(19) United States
(12) Patent Application Publication
(10) Pub. No.: US 2008/0264927 A1
(43) Pub. Date: Oct. 30, 2008

(54) COOKING RANGE HAVING A MOTORIZED STOVE BASE

(76) Inventor: ZHENG PENG, Ypsilanti, MI (US)

Correspondence Address: ZHAOXIA XU, 4694 SYCAMORE DR., YPSILANTI, MI, 48197, US

(21) Appl. No.: 11/741,061

(22) Filed: Apr. 27, 2007

(51) Int. Cl. H05B 3/68

(52) U.S. Cl. 219/452.11; 219/443.1; 219/448.11

(57) ABSTRACT

A cooking range having a motorized stove base (100). Range (100) comprises a cabinet (50) for housing an oven, a range top (54) installed on top of cabinet (50) for providing a cooking platform, at least one stove base (112) installed on top of range top (54) for supporting cooking accessories, a control panel (60) for controlling the operation of range (100), a cooking device (80) disposed on top of range top (54) for cooking food, blending/stirring means (114) installed inside cooking device (80) for blending/stirring food, a motor installed underneath stove base (112) for driving blending/stirring means (114), an adapting member (110) fixedly engaged with cooking device (80) for adapting cooking device (80) to removably stand on stove base (112), a thermostat (122) installed on stove base (112) for detecting and limiting the temperature of the bottom of cooking device (80).

### TECHNICAL FIELD AND INDUSTRIAL APPLICABILITY OF THE INVENTION

This invention generally relates to cooking ranges. More specifically, this invention relates to a cooking range that includes a motorized stove base.

### BACKGROUND OF THE INVENTION

Traditional cooking ranges, electrical or gas, have a cabinet with a range top, on which are disposed multiple cooking stoves. The cabinet further includes a door, which provides access to an oven. Also a control panel extends from the cabinet at the rear of the range top and includes variety of user input devices for controlling the operation of the cooking stoves and the oven. Cooking ranges have been a major household appliance at home to meet consumers' daily cooking needs.

However, a user has to attend cooking processes with great efforts, such as stirring food to avoid spillage, overheating of food, etc. Stirring is essential for uniform heating and proper cooking of food.

Stir-frying or sauteing of meats and vegetables has become increasingly popular in recent years as the population has become more health conscious. Some food, like creamy soups, baby food, etc. requires blending while being cooked or after being cooked. Alt these cooking processes require considerable skills and efforts in operation. Were there a way to capture and multiply the knowledge and the skills of a good chef, a whole new opportunity would be created for expansion in home food preparation and restaurant industries. Further cooking process automation is highly desired at home to cook healthy food, to save time and efforts in cooking, and to save energy and cost for general public. Innovation in cooking ranges is a primary approach in achieving this objective.

Therefore, it remains desirable to provide a cooking range that can be used to cook food with minimum attendance, that includes a motorized stove base for providing rotation power, such that food can be stirred or blended in an automatic manner to minimize the human involvement or chore during the cooking process, that can reduce the time and skills required for proper cooking, that can more precisely and reliably control the cooking temperature of the range top for specific applications, and that is innovative in design, such that it includes a cooking device that is conveniently interchangeable for different cooking techniques and that is removable for cleaning after use and dishwasher safe.

### BRIEF SUMMARY OF THE INVENTION

Accordingly, the present invention is a cooking range having a motorized stove base. This cooking range comprises a cabinet having a door for housing an oven, a range top installed on top of the cabinet for supporting cooking stoves, a control panel for controlling the operation of the cooking range, at least one stove base installed on top of the range top for supporting a cooking device, blending/stirring means installed inside the cooking device for blending/stirring food, a heating tube installed on the bottom of the cooking device for heating food, a motor installed underneath the stove base for driving the blending/stirring means, an adapting member engaged with the cooking device for adapting the cooking device to removably stand on the stove base, and a thermostat installed on the stove base for detecting and limiting the temperature of the bottom of the cooking device. As the cooking device is installed in position on the stove base, the motor is coupled with the blending/stirring means, the thermostat is engaged with the bottom of the cooking device, and the electrical terminals of the cooking device is operationally connected with an electrical port on the stove base for supplying electrical power to the cooking device.

Accordingly, the followings are some of the objects, features, and advantages of the present invention.

It is an object of the present invention to provide a cooking range having a modular cooking device that can be used to cook food with minimum attendance, leveraging cooking range resources currently in consumers' home.

It is another object of the present invention to provide a cooking range that allows automatic stirring or blending of food to save time and to reduce cooking skill requirements for consumers in their daily cooking.

It is a feature of the present invention that this cooking range includes at least one stove base that includes a motor for providing rotation power to drive a blade or a stirrer for blending food or stirring food while food being cooked.

It is another feature of the present invention that a thermostat is installed on the stove base and removably engaged with the bottom of a cooking device for detecting and limiting the temperature of the bottom of the cooking device, whereby more accurate temperature control can be achieved for various cooking techniques.

It is a further more feature of the present invention that an adapting member is provided for adapting the cooking device to removably stand on the stove base for cooking food or on a horizontal surface for serving food.

It is a still further more feature of the present invention that a heating tube is fixedly installed on the bottom of the cooking device. By directly installing the heating tube on the bottom heating efficiency is significantly enhanced.

It is an advantage of the present invention that the cooking range combines heating and stirring or blending for fast and efficient cooking, which automates cooking processes to reduce time, efforts, and skill requirements for consumers in their daily cooking.

It is another advantage of the present invention that various cooking devices share one common stove base, such that consumers do not have to buy many small kitchen appliances for their cooking needs. Consumers buy multiple cooking devices for various applications, which are much less expensive.

Further more features and advantages of the present invention will be readily appreciated, as the same becomes better understood after reading the subsequent description when considered in connection with the non-limiting accompanying drawings.

### BRIEF DESCRIPTION OF THE DRAWINGS

FIG. 1 illustrates a perspective view of an embodiment of the present invention, a cooking range having a motorized stove base 100.

FIG. 2 illustrates a cross-sectional view of cooking device 80.

FIG. 3 illustrates a bottom view of container 102.

FIG. 4 illustrates a top view of stove base 112.

FIG. 5 illustrates an exploded cross-sectional view of seal device 130 and coupling device 132.

FIG. 6 illustrates another cross-sectional view of cooking device 80.

FIG. 7 illustrates a cross-sectional view of an alternative design of stove base 112, a stove base 212.

FIG. 8 illustrates a cross-sectional view of motor 124 to show how motor 124 is installed inside range top 64.

### DETAILED DESCRIPTION OF THE INVENTION

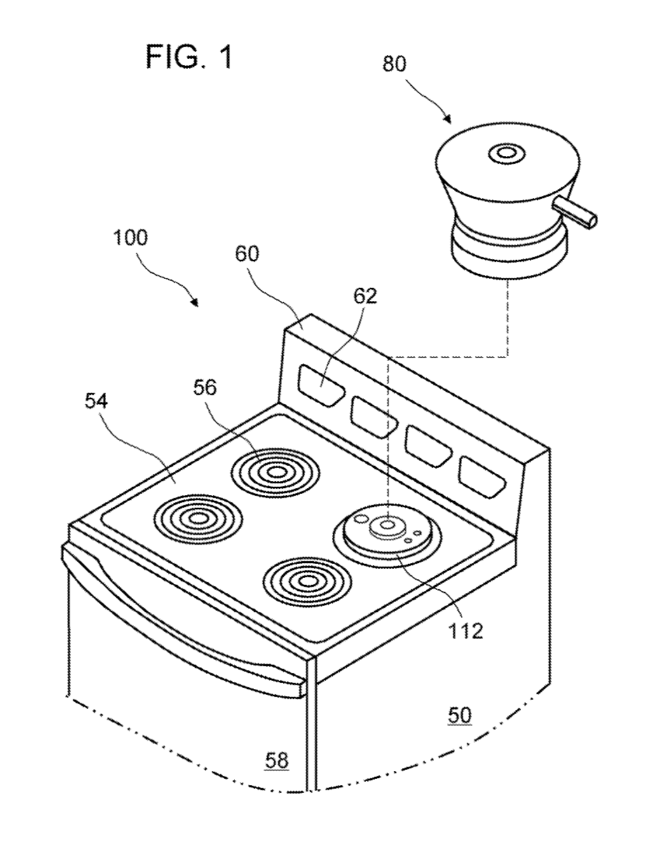

Reference is made to FIG. 1, which illustrates a perspective view of an embodiment of the present invention, a cooking range having a motorized stove base 100.

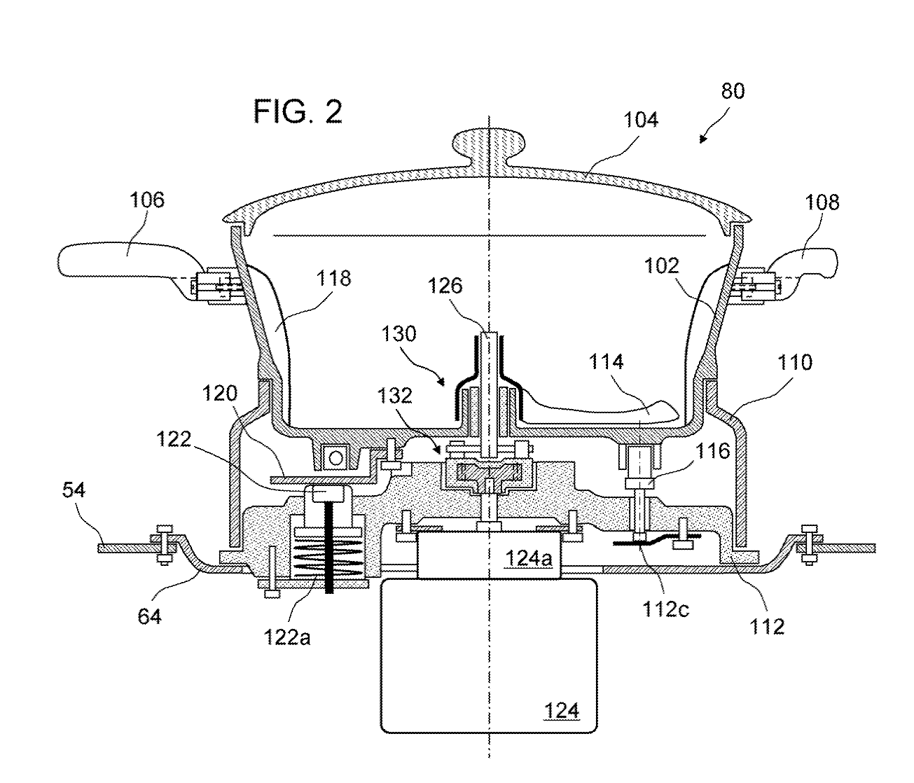

A cabinet 50 is provided for housing an oven (not shown). A range top 64 is installed on top of cabinet 50 for providing a cooking platform, on which are disposed a plurality of cooking stoves, generally designated as 56. Cabinet 60 further includes an oven door 58, which provides access to the oven. Also, a control panel 60 extends from cabinet 50 at the rear of range top 64 and includes a variety of user input devices 62 for controlling the operation of range top 54 and the oven. At least one stove base 112 is disposed on range top 54 for supporting a cooking device 80 to cook food. Cooking device 80 can be designed as a slow cooker, a fondue pot, a hot pot, a kitchen kettle, a deep-fryer, a skillet, a wok, a sauteing/stirring pan, etc., with automatic stirring or blending, to meet consumers cooking needs. Endless cooking devices can be adapted to stand on range top 54. An example of cooking device 80, a stir cooker, is illustrated in FIG. 2, which illustrates a cross-sectional view of cooking device 80.

A container 102, having an open top and a sidewall, is provided for holding and cooking food. The sidewall of container 102 is slightly tapered with a larger diameter on the top and a smaller diameter on the bottom. Container 102 is preferably coated with a non-stick material for ease of cleaning after use. When used for blending food, container 102 can be designed as a cooking jar having a larger vertical dimension.

A lid 104 is provided for closing the open top of container 102. Lid 104 is, preferably, made from a transparent material. When used for blending food, lid 104 may include a locking mechanism for preventing food from being thrown out.

A grasp handle 106 and a lift handle 108 are fixedly installed on the upper portion of the sidewall of container 102 for use of handling container 102. Handle 106 can be either generally straight or curved, like a handle for a blender, based on specific design or application requirements, as known to those skilled in the art.

An adapting member 110, having a generally tapered hollow cylindrical configuration, is provided for supporting container 102. The upper end of member 110 is fixedly engaged with the periphery of the bottom portion of container 102 and the lower end is extended downward to a predetermined distance, such that container 102 is adapted to stand on stove base 112 for cooking purposes, or on a horizontal countertop or a dinning table for serving food. Member 110 is, preferably, made from a non-metal material of low thermal conductivity, such that container 102 can directly stand on a dinning table without the risk of overheating the same. Since the upper end of member 110 is engaged with the bottom portion of container 102, the material for member 110 should be of high thermal resistance. However, other materials are readily applicable, such as metal materials, as known to those skilled in the art and suggested by this invention disclosure. Member 110 is provided also for enclosing the space underneath the bottom of container 102 into a protected space for safety consideration.

Stove base 112 is provided on range top 54 for supporting container 102. The upper portion of stove base 112 removably receives the lower end of adapting member 110. Stove base 112 is fixedly installed on top of range top 54 through an adapting plate 64. Stove base 112 is, preferably, made from a non-metal material, such as a ceramic material or a plastic material of high thermal resistance.

A stirrer 114, removably installed inside container 102, is provided for stirring food. The clearance between the lower edge of stirrer 114 and the bottom of container 102 is minimized for better stirring performance. The profile of stirrer 114 is optimized for minimizing stirring resistance, such that less motor power is required to drive stirrer 114, which saves some cost on motors. Stirrer 114 can be designed as a chopping blade for blending food at a higher motor speed. Reference is made to various blades for blenders that are currently on the market.

An electrical heating tube 116, having a generally circular configuration, is provided for heating food disposed inside container 102. Heating tube 116 is fixedly installed on the outside surface of the bottom of container 102, inserted into a groove formed on the bottom, and disposed close to the periphery of the bottom with a predetermined distance. The two electrical terminals of heating tube 116 are extended downward to a predetermined distance and are adapted to removably engage with an electrical power supply, as container 102 is installed in position on stove base 112. There are significant advantages of installing heating tube 116 directly on the bottom of container 102. These advantages include saving a significant amount of material for building a full heater that has a thermal diffusion plate, resulting in space and cost saving, higher heat transfer efficiency, etc. Other heating mechanisms are readily applicable, such as induction heating, as known to those skilled in the art and suggested by this invention disclosure. For a blending devices since the diameter of the bottom is much smaller than that for a cooker, heating tube 116 is, preferably, disposed substantially close to the peripheral outer rim of the bottom of container 102.

A plurality of co-rotation prevention members 118 is integrally constructed inside container 102, on the sidewall, for preventing food pieces from co-rotating with stirrer 114, as stirrer 114 rotates. Members 118 include an elongated member, preferably, rib-shaped, that extends generally vertical along the sidewall of container 102. The upper ends of members 118 extend substantially to the upper portion of container 102. Members 118 are preferably disposed substantially close to handles 106 or 108, such that members 118 would not obstruct food unloading. Members 118 extend inward to a predetermined distance, away from the sidewall of container 102. The predetermined distance is determined based on the size of container 102. Proper clearance between members 118 and stirrer 114 should be maintained. When food co-rotates with stirrer 114 and runs against members 118, as stirrer 114 rotates, food pieces at a higher level close to members 118 would be stopped and tumbled down due to gravity, resulting in better mixing or stirring of food, thereby facilitating heat transfer to and uniform heating of food. For a blending device, member 118 acts as a deflector for deflecting liquid flow directions for facilitating blending of food.

A thermo plate 120, made from a metal material of high thermal conductivity, is fixedly installed on the bottom of container 102, at a location substantially close to heating tube 116, for removably engaging a thermostat 122. Thermostat 122 is installed on stove base 112 and removably engaged with thermo plate 120 for detecting the temperature of the bottom of container 102, as container 102 is installed in position on stove base 112. Such temperature is used to control the electrical power to heating tube 116. The upper end of thermostat 122 protrudes upward above the upper surface of stove base 112 with pre-loading, e.g., biased via a spring member 122a. Thermostat 122 can be a digital sensor, such as a NTC or PTC, or an adjustable thermostat, or simply a temperature switch, as known to those skilled in the art and suggested by this invention disclosure.

A motor 124 is installed underneath stove base 112 for providing rotation power to stirrer 114. Motor 124 is removablely coupled with a drive shaft 126, as container 102 is installed in position. Drive shaft 126 is threaded through a central aperture on the bottom of container 102. The upper end of shaft 126 is engaged with stirrer 114 and the lower end of shaft 126 is coupled with motor 124 through a coupling device 132. A seal device 130 is provided for sealing off the interface between shaft 126 and the bottom of container 102.

Motor 124 includes a reduction device 124a for adjusting the output speed. Device 124a is a mechanical gearbox having at least two speed settings, a higher rotation speed for blending food and a lower rotation speed for stirring food. Motor speed adjustment can also be achieved through an electrical control module or a combination of both mechanical and electrical, as know to those skilled in the art.

Container 102 is adapted to stand on stove base 112 to be used as a pan for cooking food. As container 102 is properly installed in position on stove base 112, motor 124 is removably coupled with drive shaft 126, thermostat 122 is engaged with thermo plate 120, or directly with the bottom of container 102, and the electrical terminals of heating tube 116 are connected with an electrical port 112c that is installed on stove base 112.

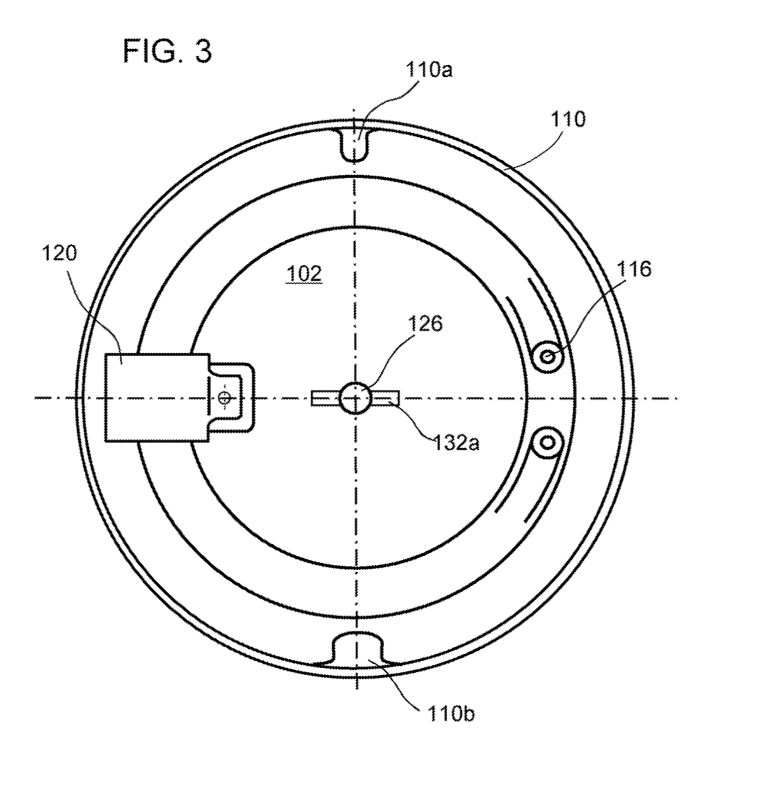

FIG. 3 illustrates a bottom view of container 102 to depict the general layout of various components disposed on the bottom. Two position guides, generally designated as 110a and 110b, protrude inward a predetermined distance from the inner surface of adapting member 110 for guiding container 102 in position on stove base 112 and for preventing container 102 from rotating with respect to stove base 112.

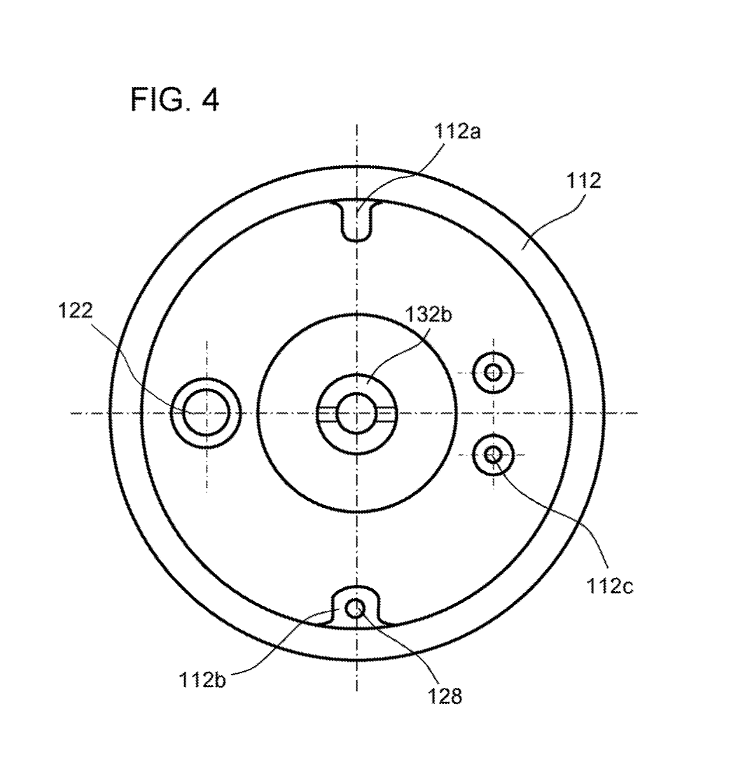

FIG. 4 illustrates a top view of stove base 112 to depict the general layout of various components disposed on the top. Two base guides, generally designated as 112a and 112b, are provided for removably receiving position guides 110a and 110b, respectively. Electrical port 112c is disposed on top of stove base 112 for removably receiving the electrical terminals from heating tube 116, such that electrical power from stove base 112 can be provided to heating tube 116, as container 102 is installed in position on stove base 112. An in-position detector 128 is installed on stove base 112 for detecting whether container 102 is properly installed or not.

Detector 128 is disposed at the bottom of base guide 112b. The upper end of detector 128 protrudes a predetermined distance above the bottom of guide 112b, such that when container 102 is installed in position on stove base 112, the lower end of position guide 110b would press with a force on detector 128 to confirm that container 102 is well positioned. Detector 128 is a switch device, which deactivates heating tube 116 if container 102 is not properly installed on stove base 112.

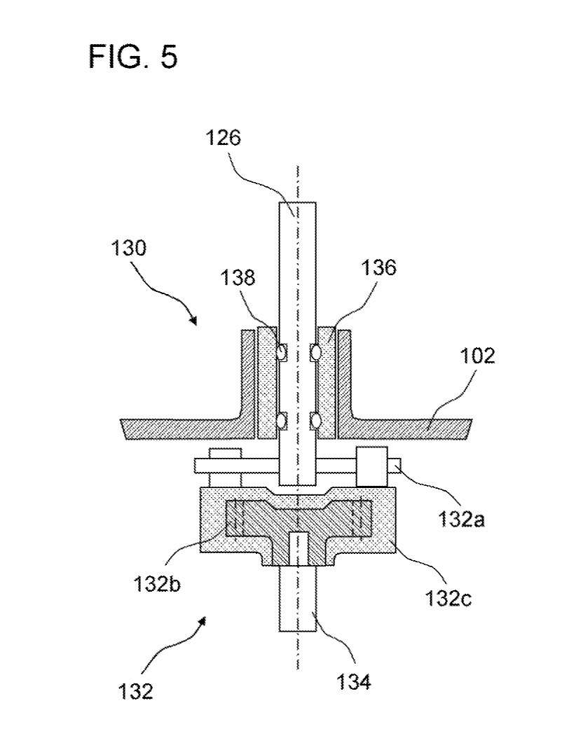

FIG. 5 illustrates an exploded cross-sectional view of seal device 130 and coupling device 132. Seal device 130 comprises a bushing member 136 and a packing member 138. Coupling device 132 includes an upper coupling element 132a and lower coupling element 132b.

Drive shaft 126 is threaded through the central aperture on the bottom of container 102. The upper end of shaft 126 is engaged with stirrer 114 and the lower end of shaft 126 extends downward through the central aperture on the bottom of container 102, leading to coupling device 132. Coupling element 132a is engaged with the lower end of shaft 126. Coupling element 132b is engaged with a motor shaft 134. A thermal insulation material 132c is provided in between element 132a and motor shaft 134 for preventing heat from transferring from element 132a to motor shaft 134, such that heat transferred from the bottom of container 102 is prevented from passing through to motor shaft 134.

Bushing 136 is co-axial to shaft 126 and is fixedly and sealingly engaged with the bottom of container 102. Packing 138 is inserted inside a groove cut around shaft 126. A plurality of packing 138 can be provided for more reliable sealing, as known to those skilled in the art. When inserted into bushing 136 together with shaft 126, packing 138 is compressed and squeezed against shaft 126 and bushing 136 to seal off the interface thereof. Bushing 136 extends upward to a predetermined height above the bottom of container 102, such that the upper end of bushing 136 and packing 138 are disposed above the bottom of container 102 and such that the requirement on seal device 130 is significantly reduced. The clearance between bushing 136 and shaft 126 is minimized for ideal sealing performance, but, at the same time, shaft 126 should be able to rotate with minimal function resistance, which requires high precision of the fitting surfaces thereof.

Materials for packing 138 are extremely important when selecting the proper packing for an application. Basic requirements include heat resistance, wearing resistance, elasticity, etc.

Seal device 130 can, alternatively, take many other forms, such as bushing, labyrinth, packing, or combinations of multiple forms for ideal performance, as known to those skilled in the art and suggested by this invention disclosure.

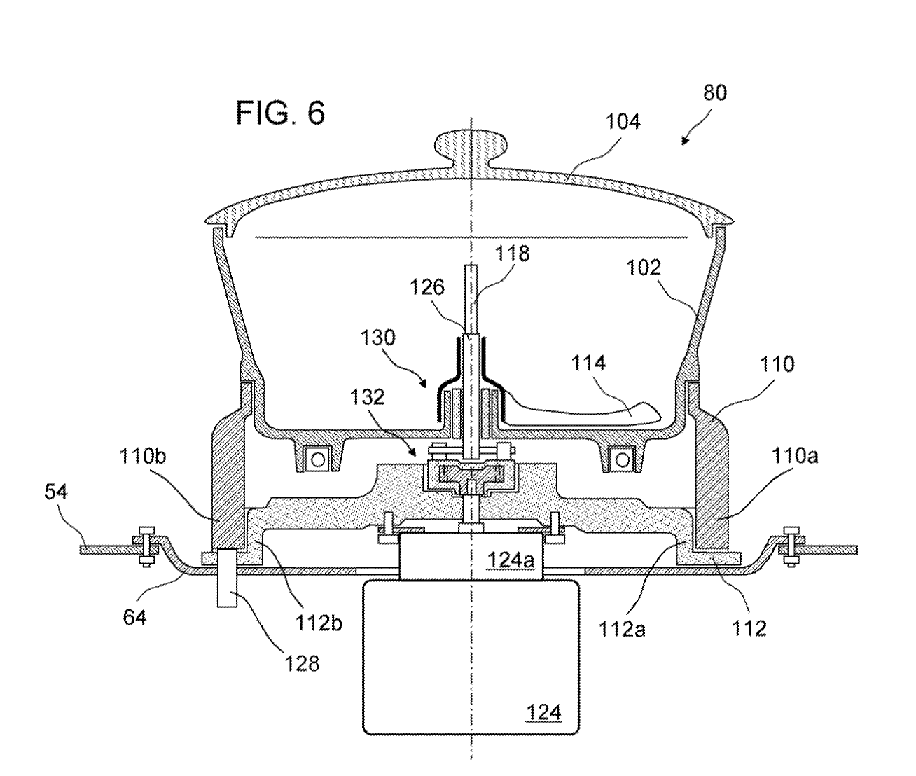

FIG. 6 illustrates another cross-sectional view of cooking device 80 to better describe how container 102 is installed on stove base 112. Position guides 110a and 110b are inserted into base guides 112a and 112b, respectively, such that container 102 is removably locked in position on stove base 112, limiting the rotation of container 102 with respect to stove base 112.

Container 102 can have various designs, varying the depth, or the upper diameter, or both, to be adapted for various applications, such as designed as slow cooking pans, fondue pots, hot pots, kitchen kettles, deep-frying pans, skillet pans, woks, grill pans, etc. While different pans are used, stove base 112 remains the same.

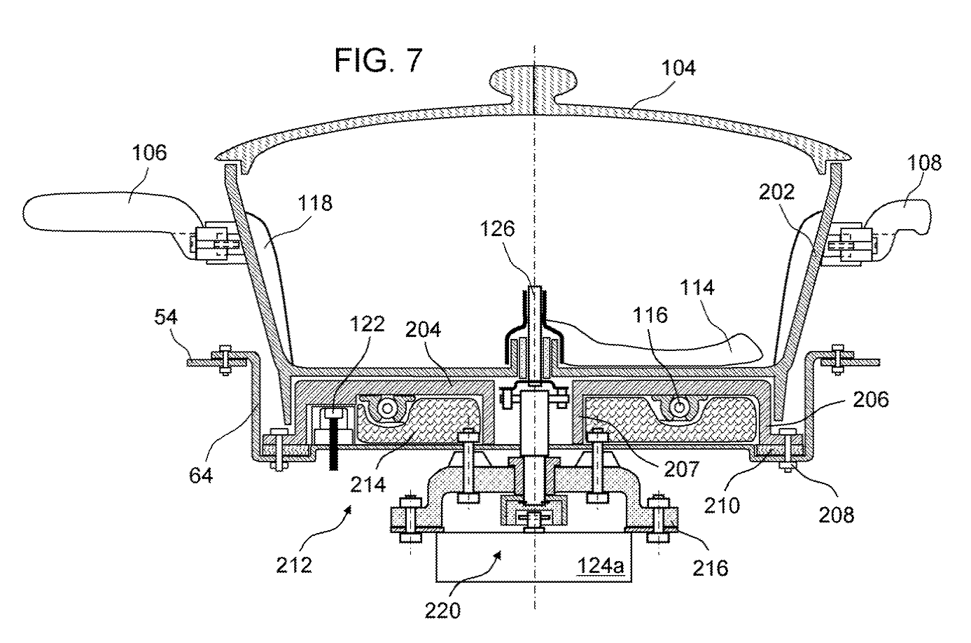

FIG. 7 illustrates a cross-sectional view of an alternative design of stove base 112, a stove base 212. Some components or devices are similar. Similarity is in the sense of both functionality and configuration. Therefore, similar components or devices are denoted with similar reference numbers to avoid repetitive explanations. Reference is made to stove base 112 for detailed information on these similar components or devices.

Stove base 212 includes a heater with a thermal diffusion plate 204, having a disc-shape configuration and a predetermined thickness. Plate 204 is provided for thermal diffusion and for supporting and heating a cooking utensil 202. Plate 204 is preferably made from a metal material of high thermal conductivity. Heating tube 116 is fixedly installed on the bottom of plate 204 for providing heating power. Thermostat 122 is installed on the bottom of plate 204 for detecting and limiting the temperature of plate 204.

A heater sidewall 206 extends from the peripheral outer rim of plate 204 downward to a predetermined distance. Sidewall 206 is provided for enclosing the space underneath plate 204 and can be an integral part of plate 204, or a separate part engaged with plate 204. The lower end of sidewall 206 is fixedly and sealingly engaged with the bottom of adapting plate 64 through a plurality of bolts 208. A heater inner wall 207 extends from a central hole opened on plate 204 downward to the bottom of adapting plate 64. Wait 207 is provided for enclosing the space underneath plate 204 and can be an integral part of plate 204, or a separate part engaged with plate 204.

A ring shaped thermal insulation member 210 is installed in between the tower end of sidewall 206 and the bottom of adapting plate 64 for preventing heat from transferring from plate 204 to adapting plate 64 through sidewall 206, thereby reducing heat loss and avoiding overheating of adapting plate 64.

A thermal insulation material 214 is inserted into the space enclosed by plate 204, sidewall 206, inner wall 207, and the bottom of adapting plate 64 to reduce heat loss.

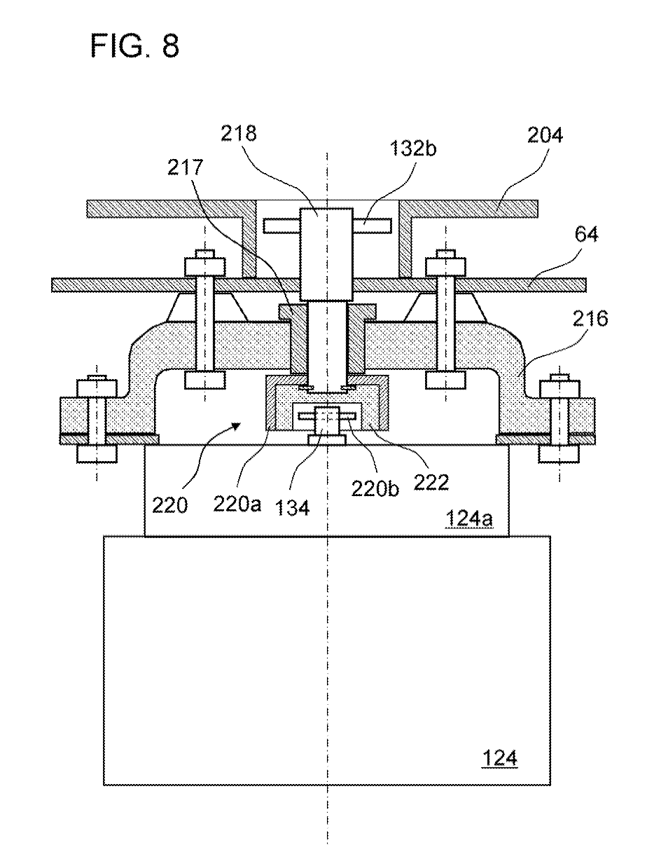

Reference is made to FIG. 8, which illustrates a cross-sectional view of motor 124 to show how motor 124 is installed inside range top 54, Motor 124 is installed on the bottom of plate 64 through an adapting frame 216, which is, preferably, made from a non-metal material of high thermal resistance. A bearing element 217 is installed at the center of frame 216 for supporting an intermediate shaft 218 in position. The tower end of shaft 218 is coupled with motor shaft 134 through a coupler 220. Coupler 220 includes a upper coupling element 220a, which is engaged with shaft 218, a lower coupling element 220b, which is engaged with motor shaft 134, and a insulation member 222, which is disposed in between coupling elements 220a and 220b, for preventing heat from transferring from shaft 218 to shaft 134, such that motor 124 is not overheated with the heat transferred from shaft 218, which is in substantial vicinity of thermal diffusion plate 204.

Accordingly, readers wilt see that this cooking range of the present invention includes a motorized stove base that is equipped with a motor for providing rotation power to a cooking device. The cooking device includes a stirrer for stirring food or a blade for blending food. The cooking process is fully automatic, thereby minimizing human involvement and chore of cooking. The cooking device is removable from the stove base, such that the cooking device is convenient for cleaning after use and dishwasher safe. Many cooking devices of various applications share one common stove base, such that consumers do not have to buy many small kitchen appliances for their cooking needs, and instead, they are able to buy various cooking devices or utensils, as accessories, which are much less expensive than full appliances.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A cooking range having a motorized stove base, said cooking range comprising:
a range top for supporting cooking stoves;
a control panel for controlling the operation of said cooking range;
at least one stove base installed on top of said range top for supporting a cooking device;
a motor installed underneath said at least one stove base for providing rotation power to said cooking device;
wherein said motor is removably coupled with a drive shaft and said drive shaft is coupled with a blade or a stirrer installed inside said cooking device for blending food or stirring food, and
wherein said at least one stove base is adapted for processing food and/or cooking food.

2. A cooking range having a motorized stove base as defined in claim 1, wherein said at least one stove base includes a thermostat installed on top of said at least one stove base for detecting and limiting the temperature of the bottom of said cooking device and whereby more accurate cooking temperature control can be achieved.

3. A cooking range having a motorized stove base as defined in claim 1, wherein said at least one stove base includes an electrical port installed on top of said at least one stove base for providing electrical power to said cooking device.

4. A cooking range having a motorized stove base as defined in claim 1, wherein said motor includes a reduction device for adjusting the output rotation speed of said motor, such that said at least one stove base is adapted for blending food at a higher speed or stirring food at a lower speed.

5. A cooking range having a motorized stove base as defined in claim 11 wherein said motor is coupled with said drive shaft through a coupling device, said coupling device includes a insulation member, such that heat transferred from said drive shaft is prevented from passing through to said motor through said coupling device, and whereby said motor is not overheated with the heat transferred from the bottom of said cooking device.

6. A cooking range having a motorized stove base, said cooking range comprising:
a range top for supporting cooking stoves;
a control panel for controlling the operation of said cooking range;
a cooking device disposed on top of said range top for cooking food;
blending/stirring means installed inside said cooking device for blending/stirring food;
at least one stove base installed on top of said range top for supporting said cooking device;
a motor installed underneath said at least one stove base for driving said blending/stirring means;
wherein said motor is removably coupled with a drive shaft and said drive shaft is coupled with said blending/stirring means;
an adapting member fixedly engaged with said cooking device for adapting said cooking device to removably stand on said at least one stove base; and
a thermostat installed on said at least one stove base for detecting and limiting the temperature of the bottom of said cooking device.

7. A cooking range having a motorized stove base as defined in claim 6, wherein said thermostat is biased with a spring member, the upper end of said thermostat protrudes upward above the upper surface of said at least one stove base, and when said cooking device is disposed in position on said at least one stove base said thermostat is adapted to be engaged with the bottom of said cooking device.

8. A cooking range having a motorized stove base as defined in claim 6, wherein said drive shaft is threaded through a central aperture opened on the bottom of said cooking device and said cooking device includes a seal device for sealing off the interface between said drive shaft and said central aperture on the bottom of said cooking device.

9. A cooking range having a motorized stove base as defined in claim 8, wherein said seal device includes a bushing member fixedly and sealingly engaged with said central aperture on the bottom of said cooking device and said drive shaft is threaded through said bushing member.

10. A cooking range having a motorized stove base as defined in claim 9, wherein said seal device includes at least one packing member adapted to be squeezed against said drive shaft and said bushing member for sealing off the interface thereof.

11. A cooking range having a motorized stove base as defined in claim 6, wherein said motor is coupled with said drive shaft through a coupling device, said coupling device includes a insulation member, such that heat transferred from said drive shaft is prevented from passing through to said motor through said coupling device, and whereby said motor is not overheated with the heat transferred from the bottom of said cooking device.

12. A cooking range having a motorized stove base as defined in claim 6, wherein said adapting member includes at least one position guide for guiding said cooking device in position on said at least one stove base and for preventing said cooking device from rotating with respect to said at least one stove base.

13. A cooking range having a motorized stove base as defined in claim 6, wherein said adapting member has a generally hollow cylindrical configuration, the upper end of said adapting member is routed over the lower portion of said cooking device and is fixedly engaged thereof, and the lower end of said adapting member is routed over the upper portion of said at least one stove base and is removably engaged thereof.

14. A cooking range having a motorized stove base as defined in claim 6, wherein said cooking device includes heating means fixedly installed on the bottom of said cooking device for heating food and the electrical terminals of said heating means are adapted to be removably engaged with an electrical port disposed on said at least one stove base for supplying electrical power to said heating means, as said cooking device is installed in position on said at least one stove base.

15. A cooking range having a motorized stove base as defined in claim 6, wherein said at least one stove base includes an in-position detector installed on said at least one stove base for detecting whether said cooking device is properly installed on said at least one stove base or not and wherein if said cooking device is not properly installed on said at least one stove base said in-position detector shuts off electrical power to said cooking device.

16. A cooking range having a motorized stove base as defined in claim 6, wherein said cooking device includes:
a container having an open top and a sidewall for holding and cooking food;
a lid for closing the open top of said container;
heating means for heating food disposed inside said container; and
wherein said heating means is fixedly installed on the bottom of said container.

17. A cooking range having a motorized stove base as defined in claim 16, wherein said heating means includes a heating tube of a generally circular configuration, said heating tube is fixedly installed the bottom of said container, and said heating tube is disposed close to the periphery of the bottom of said container with a predetermined distance.

18. A cooking range having a motorized stove base as defined in claim 16, wherein said cooking device includes at least one co-rotation prevention member installed on the sidewall of said container for preventing food from co-rotation with said blending/stirring means, as said blending/stirring means rotates.

19. A cooking range having a motorized stove base as defined in claim 18, wherein said at least one co-rotation prevention member is an elongated member, is extended generally vertical along the sidewall of said container, is extended from the lower portion of said container upward to the upper portion of said container, and is extended inward from the sidewall of said container to a predetermined distance, away from the sidewall of said container.

20. A cooking range having a motorized stove base, said cooking range comprising:
a range top for supporting cooking stoves;
a control panel for controlling the operation of said cooking range,
a cooking device disposed on top of said range top for cooking food;
blending/stirring means installed inside said cooking device for blending/stirring food;
at least one stove base installed on top of said range top for supporting said cooking device;
wherein said at least one stove base includes an electrical heater having a thermal diffusion plate and a heating tube and said heating tube is fixedly installed on the bottom of said thermal diffusion plate for providing heating power;
a motor installed inside said range top for driving said blending/stirring means;
wherein said motor is removably coupled with a drive shaft and said drive shaft is coupled with said blending/stirring means; and
a thermostat installed on the bottom of said thermal diffusion plate for detecting and limiting the temperature of said electrical heater.

21. A cooking range having a motorized stove base as defined in claim 20, wherein said electrical heater includes an outer sidewall extended downward from the peripheral outer rim of said thermal diffusion plate to a predetermined distance, the lower end of said outer sidewall is fixedly installed on said range top, such that the space underneath said thermal diffusion plate is contained, and whereby food debris or cooking liquids are prevented from dropping or flowing into the space under said thermal diffusion plate.

22. A cooking range having a motorized stove base as defined in claim 21, wherein a thermal insulation material is inserted inside the space enclosed by said thermal diffusion plate, said outer sidewall, and the upper surface of said range top for thermal insulation.

23. A cooking range having a motorized stove base as defined in claim 20, wherein said motor is installed on said range top through an adapting frame member, said adapting frame member includes a bearing member for supporting an intermediate shaft, the upper end of said intermediate shaft is removably coupled with said drive shaft, and the lower end of said intermediate shaft is coupled with said motor.

24. A cooking range having a motorized stove base as defined in claim 23, wherein the lower end of said intermediate shaft is coupled with said motor through a coupling device, said coupling device includes a insulation member, such that heat transferred from said intermediate shaft is prevented from passing through to said motor through said coupling device, and whereby said motor is not overheated with the heat transferred from the bottom of said cooking device.
